(19) United States
(12) Patent Application Publication
(10) Pub. No.: US 2012/0129464 A1
(43) Pub. Date: May 24, 2012

(54) RADIO COMMUNICATION SYSTEM, ACCESS POINT AND RADIO COMMUNICATION METHOD

(75) Inventor: Daisuke YAMADA, Nagoya-shi (JP)

(73) Assignee: Buffalo Inc., Nagoya-shi (JP)

(21) Appl. No.: 13/302,478

(22) Filed: Nov. 22, 2011

(30) Foreign Application Priority Data
Nov. 22, 2010 (JP) 2010-260394

(51) Int. Cl. H04W 40/12; H04W 24/00

(52) U.S. Cl. 455/67.11; 455/39

(57) ABSTRACT

A radio communication system including a radio terminal capable of establishing a plurality of transmission paths, includes: a selecting unit for selecting transmission paths to be used for transmitting user data from among a plurality of transmission paths; and an establishing unit for establishing the transmission paths selected by the selecting unit, wherein the selecting unit selects the transmission paths to be used for transmitting the user data based on quality information required for transmitting the user data.

### CROSS REFERENCE TO RELATED APPLICATIONS

This application is based upon and claims the benefit of priority from prior Japanese Patent Application No. 2010-260394, filed on Nov. 22, 2010; the entire content of which is incorporated herein by reference.

### BACKGROUND

1. Technical Field

The present invention relates to a radio communication system, an access point and a radio communication method for a radio terminal capable of establishing a plurality of transmission paths.

2. Description of the Related Art

In recent years, the MIMO (multiple input mutiple output) technique has been drawing attention as a technique capable of increasing transmission rate (e.g., IEEE802.11n, “Part 11; Wireless LAN Medium Access Control (MAC) and Physical Layer (PITY) Specification”, 29^{th} Oct. 2009”).

According to the MIMO technique, a transmitter can send out different pieces of data via its one or more antennas and a receiver can receive the different pieces of data via its one or more antennas, so that transmission capacity can be increased and communication reliability can be improved.

Between a radio terminal and an access point, a plurality of transmission paths can be established. In such a case, the above-described technique does not obviously define the number of transmission paths to be established. Further, the above-described technique does not obviously define which transmission paths are selected from among the established transmission paths.

### SUMMARY OF THE INVENTION

According to a first feature of this invention, there is provided a radio communication system (radio communication system 100) including a radio terminal (radio terminal 10) capable of establishing a plurality of transmission paths, the radio communication, system comprising: a selecting unit (selecting unit 24) for selecting a transmission path to be used for transmitting user data from among plural transmission paths; and an establishing unit (establishing unit 25) for establishing the transmission path selected by the selecting unit, wherein the selecting unit selects the transmission path to be used for transmitting the user data based on quality information required for transmitting the user data.

According to the first feature of the present invention, the radio communication system further comprises a measuring unit (measuring unit 23) for measuring the throughputs associated with the established transmission paths, and the selecting unit excludes those transmission paths with which throughputs lower than a predetermined threshold value are associated, from transmission paths available for transmitting the user data.

According to the first feature of the present invention, the establishing unit sequentially establishes transmission paths before communication is started; and the measuring unit sequentially measures throughputs with respect to the available transmission paths.

According to the first feature of the present invention, the establishing unit sequentially establishes transmission paths after communication has been started; and the measuring unit sequentially measures the throughputs with respect to the established transmission paths.

According to a second feature of the present invention, there is provided an access point that communicates with a radio terminal capable of establishing a plurality of transmission paths, the access point comprising: a selecting unit for selecting a transmission path to be used for transmitting user data from among transmission paths; and an establishing limit for establishing those transmission paths which have been selected by the selecting unit, wherein the selecting unit selects the transmission paths to be used for transmitting the user data based on quality information required for transmitting the user data.

According to a third feature of the present invention, there is provided a radio communication method applied to a radio communication system including a radio terminal capable of establishing a plurality of transmission paths, the method comprising: the step A of selecting a transmission path to be used for transmitting user data from among transmission paths, based on quality information required for transmitting the user data; and the step B of establishing the transmission path selected in the step A.

### BRIEF DESCRIPTION OF THE DRAWINGS

FIG. 1 illustrates a radio communication system 100 as a whole according to a first embodiment.

FIG. 2 shows in block diagram the circuit structure of an access point 20 according to the first embodiment.

FIG. 3 illustrates a message format according to the first embodiment.

FIG. 4 is a sequence diagram illustrating an operation of a radio communication system 100 according to the first embodiment.

FIG. 5 is a sequence diagram illustrating the continued part of the sequence diagram shown in FIG. 4.

### DETAILED DESCRIPTION

A radio communication system according to an embodiment of the present invention will be described below with reference to the attached drawings. Throughout the drawings, the same or similar parts are denoted with the same or similar reference numerals.

It should be noted here that the figures are schematically drawn and the dimensions of each part differ from the actual ones. Therefore, the specific dimensions of parts should be determined in consideration of the following descriptions. Further, it is needless to say that the dimensions of a part or an element may differ in different figures.

### Overview of Embodiments

The radio communication system according to the embodiment includes a radio terminal capable of establishing a plurality of transmission paths. The radio communication system includes a selecting unit for selecting available transmission paths to be used for transmitting user data from among a plurality of transmission paths, and an establishing unit for establishing the transmission paths selected by the selecting unit. The selecting unit selects the transmission paths to be used for transmitting the user data based on quality information required for transmitting the user data.

The quality information required for transmitting the user data includes, for example, an available band width required for transmitting the user data, the frequency of transmitting packets, a transmission rate required for the physical layer, a frame size required for transmitting the user data.

According to the embodiment, the selecting unit, based on the quality information required for transmitting the user data, selects the transmission paths to be used for transmitting the user data. Therefore, under a circumstance where a plurality of transmission paths can be established, appropriate transmission paths can be selected (set) as the transmission paths to be used for transmitting the user data.

### First Embodiment

### (Radio Communication System)

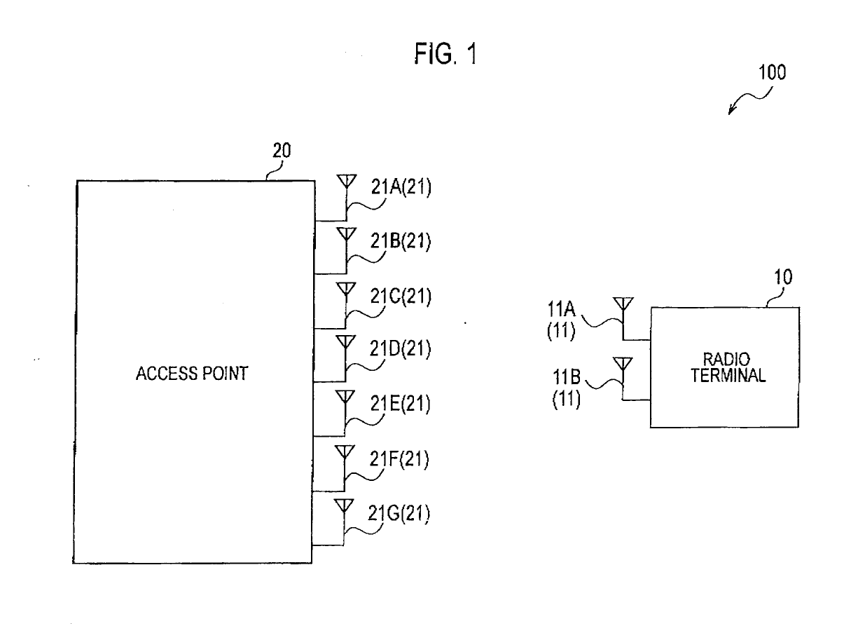

A radio communication system according to a first embodiment will be described below with reference to the attached drawings. FIG. 1 illustrates the radio communication system 100 according to the first embodiment.

As illustrated in FIG. 1, the radio communication system 100 includes a radio terminal 10 and an access point 20.

The radio terminal 10 communicates the user data with the access point 20. The radio terminal 10 each includes a plurality of antennas 11 (herein, antennas 11A, 11B).

The access point 20 communicates the user data with the radio terminal 10. The access point 20 includes a plurality of antennas 21 (herein, antennas 21A to 21G).

The first embodiment uses the multiple input multiple output (MIMO) technique. Accordingly, transmission paths can be established between each of the antennas 11 of the radio terminal 10 and each of the antennas 21 of the access point 20. In other words, according to the first embodiment, 42 (₇P₂) kinds of transmission paths can be established.

The radio terminal 10 and the access point 20 have, for example, a radio communication function based on IEEE802.11n.

### (Access Point)

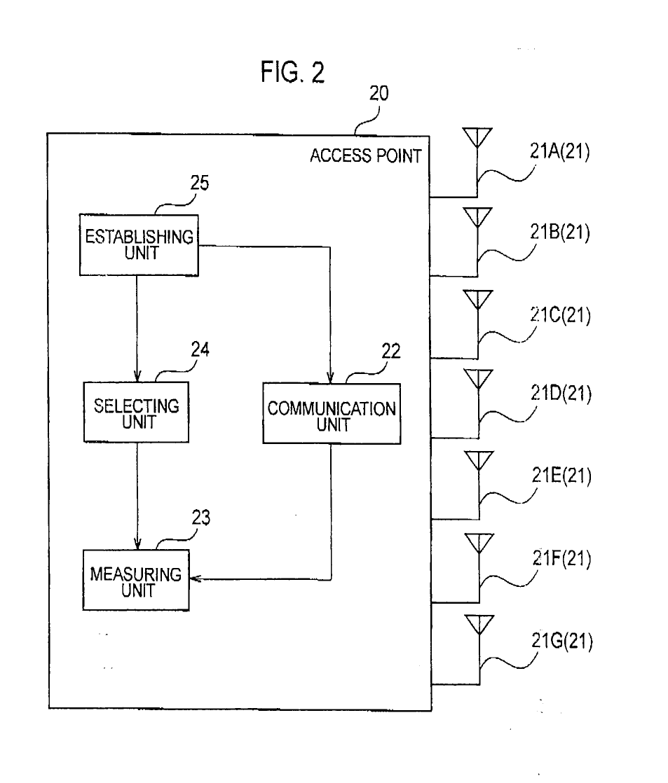

The access point according to the first embodiment will be described with reference to FIG. 2. FIG. 2 shows in block diagram the circuit structure of the access point 20 according to the first embodiment.

As illustrated in FIG. 2, the access point 20 includes the plurality of antennas 21, a communication unit 22, a measuring unit 23, a selecting unit 24, and an establishing unit 25.

Each antenna 21 transmits a signal via an individual transmission path. Also, each antenna 21 receives a signal via the individual transmission path.

The communication unit 22 transmits signals via the respective antennas 21.

Similarly, the communication unit 22 receives signals via the respective antennas 21. Further, the communication unit 22 performs the modulation, demodulation, encoding, and decoding of signals.

Further, the communication unit 22 has the function of performing communication according to a protocol such as the link layer topology discovery (LLTD).

The measuring unit 23 measures throughputs with respect to the transmission paths. In fact, the establishing unit 25 described below sequentially establishes the transmission paths between the radio terminal 10 and the access point 20, and the measuring unit 23 measures the throughputs with respect to the transmission paths thus established (hereafter, referred to as “throughput scanning process”.

The throughput scanning process may be performed before and/or after the start of communication between the radio terminal 10 and the access point 20.

The throughput may be expressed in terms of link rate, error rate, or actual measurement rate.

The link rate signifies the theoretical value of the transmission of data (e.g., user data) in the communication between the radio terminal 10 and the access point 20. For example, when the adaptive modulation coding (AMC) is under way, the link rate means the theoretical value calculated according to a modulation method or an encoding method selected on the basis of transmission environment under consideration. The link rate may be a rate in the physical layer or a rate in a layer higher than the physical layer.

The error rate denotes an error rate with respect to the data (e.g., user data) in the communication between the radio terminal 10 and the access point 20. For example, the error rate may be a bit error rate or a symbol error rate. Needless to say, the higher is the error rate, the lower becomes the throughput.

The actually measured rate is a rate obtained through the actual measurement of the transmission rate of the data (e.g. user data) in the communication between the radio terminal 10 and the access point 20. For example, the actually measured rate is calculated on the basis of an echo message traveling back and forth between the radio terminal 10 and the access point 20.

To be more precise, the actually measured rate signifies the time (e.g. Average time) required for echo message to successfully travel back and forth once. Regarding details of the actual rate, for example, Japanese Patent Laid-Open No. 2009-129933 is to be referred to. The actually measured rate may be a rate in the physical layer, or a rate in a layer higher than physical layer.

The selecting unit 24 selects transmission paths (i.e., transmission paths to be set between the radio terminal 10 and the access point 20) to be used for transmitting the user data. The “selection of transmission paths” includes the idea of selecting the number of transmission paths to be used for transmitting the user data.

Further, the “selection of transmission paths” includes the idea of selecting a set of transmission paths (i.e., combinations between the antennas 11 provided for the radio terminal 10 and the antennas 21 provided for the access point 20) to be used for transmitting the user data. For example, below is described a method for selecting transmission paths.

(1) Based on quality information required for transmitting the user data, the selecting unit 24 selects the transmission paths to be used for transmitting the user data. The quality information required for transmitting the user data is the information used for ensuring the quality of service (Qos). According to the first embodiment, the selecting unit 24 selects the transmission paths, based on the information (quality information) used for originally ensuring the Qos.

The quality information required for transmitting the user data includes, for example, the available band width required for transmitting the user data, the repetition number of transmitting packets, the transmission rate required by the physical layer, and the frame size required for transmitting the user data.

For example, in admission control for the Wi-Fi multimedia enhanced distributed path access (WMM-EDCA), the available band width can be requested by sending an add traffic stream request (ADDTS req.) message from the radio terminal 10 to the access point 20. In the WMM-EDCA, four categories of “audio”, “video”, “best effort”, and “back ground” are selectable as types of available band widths. Typically, the available band widths of “audio”, “video”, “best effort”, and “back ground” become wider in this order named.

For example, (a) the selecting unit 24 selects more transmission paths for a wider available band width. Alternately, the selecting unit 24 selects transmission paths having higher throughputs for a wider available band width. (b) The selecting unit 24 selects more transmission paths when the r frequency of transmitting packets is higher. Alternately, the selecting unit 24 selects transmission paths having higher throughputs for higher frequency of transmitting the packets. (c) The selecting unit 24 selects more transmission paths when for the transmission rate required in the physical layer is higher. Alternately, the selecting unit 24 selects transmission paths having higher throughputs for higher transmission rate required in the physical layer. (d) The selecting unit 24 selects more transmission paths when the frame size is larger. Alternately, the selecting unit 24 selects transmission paths having higher throughputs for frames of larger size.

In other words, the selecting unit 24 selects more transmission paths for higher quality requested depending on the quality information. Alternately, the selecting unit 24 selects transmission paths having higher throughputs for the higher quality requested depending on the quality information.

(2) As a result of the throughput scanning process, the selecting unit 24 excludes the transmission paths having throughputs lower than a predetermined threshold value from among transmission paths available for transmitting the user data. In other words, the selecting unit 24 selects transmission paths to be used for transmitting the user data from among the transmission paths having throughputs higher than the predetermined threshold.

As described above, the throughput scanning process may be performed either before or after the start of communication between the radio terminal 10 and the access point 20.

The establishing unit 25 establishes transmission paths (i.e., transmission paths to be set between the radio terminal 10 and the access point 20) to be used for transmitting the user data.

More specifically, the establishing unit 25 establishes transmission paths selected by the selecting unit 24. Further, as a part of the above-described throughput scanning process, the establishing unit 25 sequentially establishes transmission paths available between the radio terminal 10 and the access point 20.

### (Message Format)

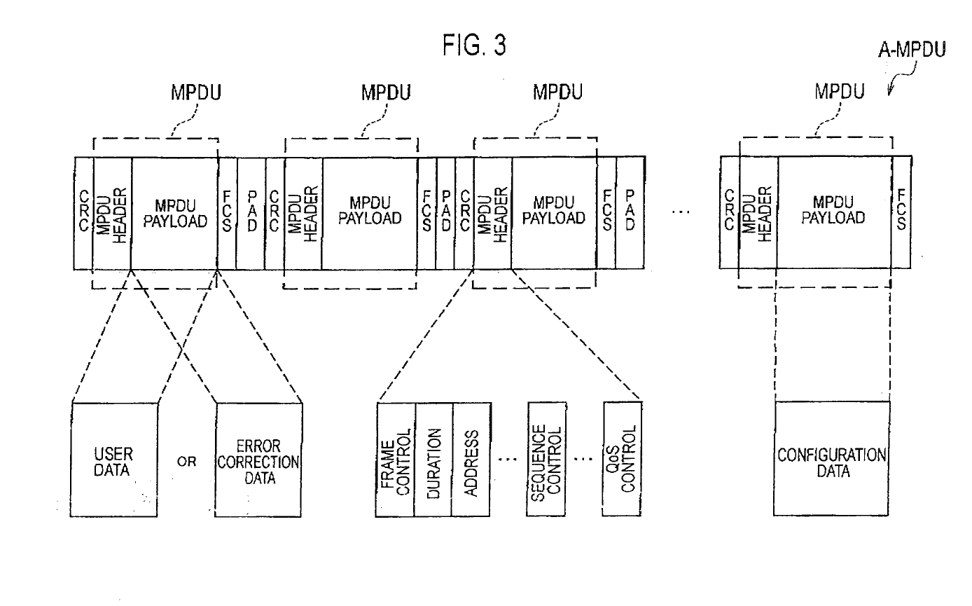

An example of a message format according to the first embodiment will be described with reference to FIG. 3. FIG. 3 illustrates an example of the message format according to the first embodiment. FIG. 3 illustrates a media access control protocol data unit (MPDU) as a data unit, and also illustrates an aggregate-MPDU (A-MPDU) as a collective data unit consisting of a plurality of data units.

As illustrated in FIG. 3, the A-MPDU includes a plurality of the MPDUs. The A-MPDU includes a cyclic redundancy check (CRC), a MPDU header, a MPDU payload, a frame check sequence (FCS), and padding data (PAD), all of which constitute one frame.

The CRC is a bit sequence used for detecting errors in one frame. The MPDU header is the header of an MPDU frame. The MPDU header includes frame control field, duration field, address field, sequence control field, and QoS control field. The frame control field contains sub-frames included in the MPDU payload. The duration field contains estimated time necessary for conveying the MPDU. The address field contains the destination of the MPDU. The sequence control field contains the sequence of the MPDUs. The QoS control field contains data indicating the quality required for the MPDU.

The MPDU payload includes the user data or error correction data. For example, when the A-MPDU includes the user data unit, the MPDU payload includes the user data. When the A-MPDU includes the error correction data unit, the MPDU payload includes the error correction data.

The FCS is a bit sequence used for detecting errors in one frame or detecting the errors.

The PAD is a bit sequence for adjusting the data length of each frame. For example, the PAD is the bit sequence for adjusting a lack of the data to match an alignment of a calculator.

### (Operation of Radio Communication System)

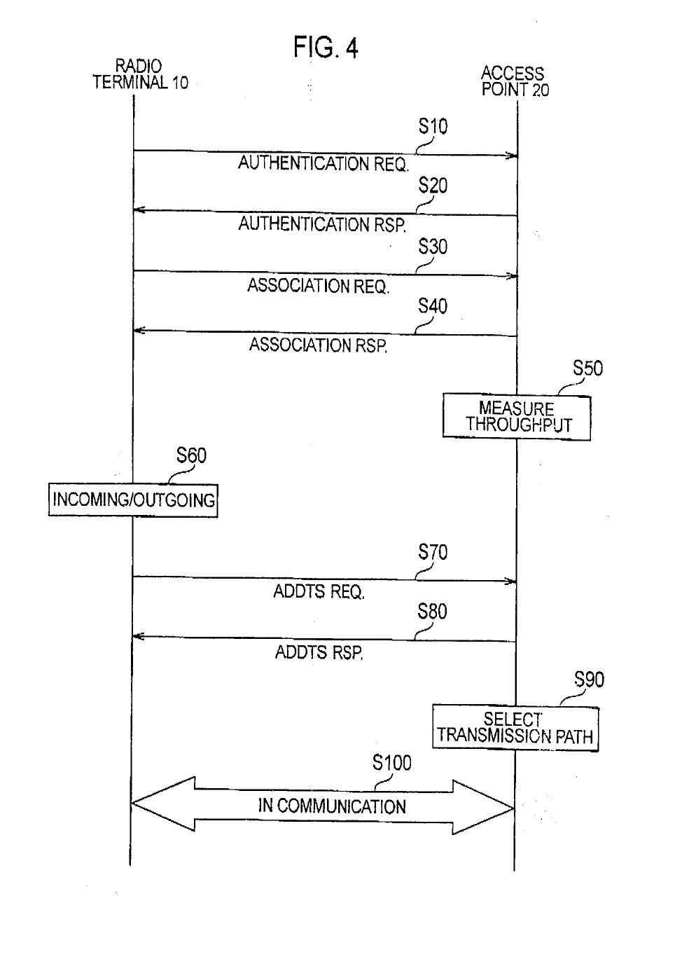

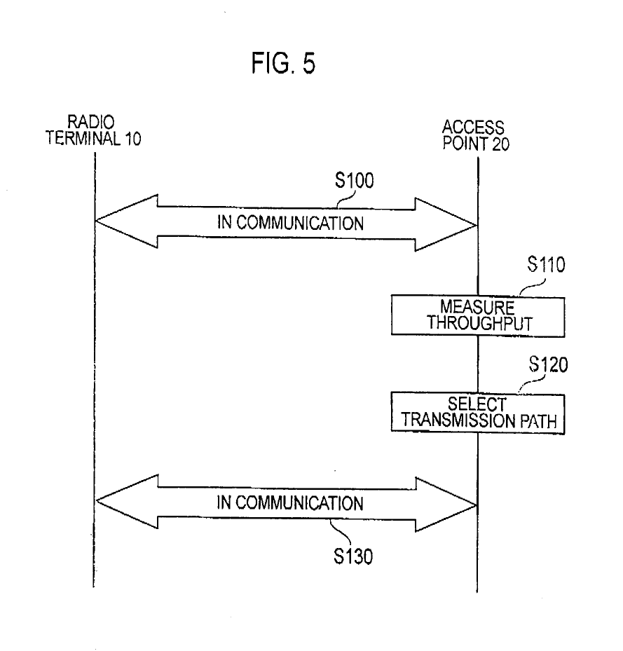

The operation of the radio communication system according to the first embodiment will be described with reference to FIGS. 4 and 5. FIGS. 4 and 5 show a sequence diagrams divided into two sheets, illustrating the operations of the radio communication system 100 according to the first embodiment.

First, a method for selecting transmission paths at the start of communication will be described with reference to FIG. 4.

As illustrated in FIG. 4, in step S10, the radio terminal 10 transmits an “Authentication Req.” message to the access point 20. In step S20, the access point 20 transmits an “Authentication Rsp.” message to the radio terminal 10. Accordingly, the procedure of authentication between the radio terminal 10 and the access point 20 is completed.

In step S30, the radio terminal 10 transmits an “Association Req.” message to the access point 20. In step S40, the access point 20 transmits an “Association Res.” message to the radio terminal 10. As a result, the procedure of connection between the radio terminal 10 and access point 20 is completed.

In step S50, the access point 20 sequentially establishes transmission paths which can be established between the radio terminal 10 and the access point 20, and then measures the throughputs of the established transmission paths (throughput scanning process).

In step S60, the radio terminal 10 performs the processes of transmission and reception.

In step S70, the radio terminal 10 transmits an “ADDIS Req” message to the access point 20. Note that the “ADDTS Req.” message includes information indicating available band width requested by the radio terminal 10.

In step S80, the access point 20 transmits an “ADDTS Rsp.” message to the radio terminal 10. For more detail, when the available band width requested by the radio terminal 10 can be ensured, the access point 20 notifies the radio terminal 10 of the permission of communication by using the “ADDTS Rsp.” message. On the other hand, when the available band width requested by the radio terminal 10 cannot be ensured, the access point 20 notifies the radio terminal 10 of the refusal of communication by using the “ADDTS Rsp.” message. When the communication is refused, the radio terminal 10 attempts to connect to another access point. The following description will continue on the assumption that the communication has been permitted.

In step S90, based on the quality information (herein, available band width) required for transmitting the user data, the access point 20 selects transmission paths to be used for transmitting the user data.

As a result of the throughput scanning process (step S50), the access point 20 excludes the transmission paths having throughputs lower than a predetermined threshold from among the available transmission paths to be used for transmitting the user data. In other words, the access point 20 selects the transmission paths to be used for transmitting the user data from among the transmission paths having throughputs higher than the predetermined threshold.

In step S100, the access point 20 establishes the transmission paths selected in step S90. Consequently, the communication of the user data is started between the radio terminal 10 and the access point 20. It is needless to say that the available band width is ensured in such communication.

Secondly, how to select transmission paths after the start of communication (during the communication) will be described with reference to FIG. 4.

As illustrated in FIG. 5, in step S100, the communication of the user data has been already performed between the radio terminal 10 and the access point 20.

In step S110, the access point 20 sequentially establishes the transmission paths which can be established between the radio terminal 10 and the access point 20, and then measures the throughputs of the established transmission paths (throughput scanning process).

In step S120, as a result of the throughput scanning process (step S110), the access point 20 excludes the transmission paths having the throughputs lower than the predetermined threshold from among the transmission paths to be used for transmitting the user data. In other words, the access point 20 selects the transmission paths to be used for transmitting the user data from among the transmission paths having the throughputs higher than the predetermined threshold.

### (Operation and Effect)

According to the embodiment, the selecting unit 24, based on the quality information required for transmitting the user data, selects the transmission paths to be used for transmitting the user data. Therefore, under the circumstance where a plurality of transmission paths can be established, appropriate transmission paths can be selected (set) as transmission paths to be used for transmitting the user data.

According to the embodiment, as a result of the throughput scanning process, the selecting unit 24 excludes the transmission paths having the throughputs lower than the predetermined threshold from among the available transmission paths to be used for transmitting the user data. Therefore, under the circumstance where a plurality of transmission paths can be established, appropriate transmission paths can be selected (set) as transmission paths to be used for transmitting the user data.

By performing the throughput scanning process before communication has been started, appropriate transmission paths can be selected (set) at the start of communication. Further, by performing the throughput scanning process after communication has been started, appropriate transmission paths can be selected (set) in accordance with changes in the transmission environment.

### EXAMPLE

An example according to the first embodiment will be described below.

Herein, as an example, a case will be described where such information as described below can be exchanged between the radio terminal 10 and the access point 20.

(a1) “Minimum data rate”: information that defines a lower limit to the available band width required for transmitting the user data (unit: Mbps)

(a2) “Minimum PHY rate”: information that defines a lower limit to the transmission rate for the physical layer (unit: bps)

(a3) “Medium time”: the frequency of transmitting the packets permitted by the access point 20 (time portion of the unit time during which the user data can be transmitted)

Further, a case will be described where the access point 20 can acquire the information described below on the basis of the state of the transmission paths being used.

(b1) “Packet error rate”: an error rate in the most recent unit time most recently (bit error rate)

(b2): “PHY rate”: a rate in the physical layer in the most recent unit time (can be calculated based on the “packet error rate”)

(b3) “Spatial utilize”: time during which the transmission path of interest is exclusively used in the most recent unit time

In the cases described above, the selecting unit 24 selects, for example, transmission paths in the following manner.

(1) The selecting unit 24 selects the transmission paths of which the “minimum, data rate” is higher than the “minimum PHY rate”. In other words, the selecting unit 24 excludes the transmission paths of which the “minimum PHY rate” is equal to or lower than the “minimum data rate”.

(2) The selecting unit 24 selects the transmission paths for which the sum (ΣPER (x)) of the “packet error rates” in unit times (x) in each of which the “PHY rate” is not lower than the “minimum PHY rate”, is smaller than threshold value (P_{thresh′}).

In other words, the selecting unit 24 excludes the transmission paths having the sum of the “packet error rate” equal to or larger than the threshold.

(3) The selecting unit 24 selects the transmission paths for each of which the “medium time” is longer than the “spatial utilize”. In other words, the selecting unit 24 excludes the transmission paths for each of which the “medium time” is equal to or shorter than the “spatial utilize”.

### Other embodiments

The present invention has been described above by way of embodiment, but the descriptions and figures constituting the disclosure are not intended to limit the present invention, From this disclosure, alternative embodiments, variations, modifications, and various techniques will become apparent for those skilled in the art.

In the above described embodiment, a case has been described where the measuring unit 23, the selecting unit 24, and the establishing unit 25 are installed in the access point 20, but the invention is not limited to such a case.

The measuring unit 23, the selecting unit 24, and the establishing unit 25 may also be installed in the radio terminal 10.

In the above described embodiment, another case has been described where the embodiment is applied to the communication between the radio terminal 10 and the access point 20, but the embodiment is not limited to such a case. The embodiment may be applied to the communication between radio terminals 10. In such a case, the measuring unit 23, the selecting unit 24, and the establishing unit 25 may be installed in the radio terminals 10.

The selecting unit 24 may include a table in which the quality requested by the quality information and the throughput are associated with each other. In such a case, the selecting unit 24 may select the transmission paths to be used for transmitting the user data in such a manner that the sum of the throughputs of the transmission paths of interest exceeds the throughput associated with the quality requested by the quality information.

What is claimed is:

1. A radio communication system including a radio terminal capable of establishing a plurality of transmission paths, comprising:
a selecting unit for selecting transmission paths to be used for transmitting user data from among a plurality of transmission paths; and
an establishing unit for establishing the transmission paths selected by the selecting unit, wherein
the selecting unit selects the transmission paths to be used for transmitting the user data based on quality information required for transmitting the user data.

2. The radio communication system according to claim 1, further comprising a measuring unit for measuring the throughputs of the respective transmission paths, wherein
the selecting unit excludes the transmission paths having throughputs lower than a predetermined threshold, from available transmission paths to be used for transmitting the user data.

3. The radio communication system according to claim 2, wherein
the establishing unit sequentially establishes transmission paths before the start of communication; and
the measuring unit sequentially measures the throughputs of the established transmission paths.

4. The radio communication system according to claim 2, wherein
the establishing unit sequentially establishes transmission paths after the start of communication; and
the measuring unit sequentially measures the established transmission paths.

5. An access point that communicates with a radio terminal capable of establishing a plurality of transmission paths, comprising:
a selecting unit for selecting transmission paths to be used for transmitting user data from among a plurality of transmission paths; and
an establishing unit that establishes the transmission paths selected by the selecting unit, wherein
the selecting unit selects the transmission paths to be used for transmitting the user data based on quality information required for transmitting the user data.

6. A radio communication method applied to a radio communication system including a radio terminal capable of establishing a plurality of transmission paths, comprising:
the step A of selecting transmission paths to be used for transmitting user data from among a plurality of transmission paths, based on quality information required for transmitting the user data; and
the step B of establishing the transmission paths selected in the step A.
